(19) United States
(12) Patent Application Publication
(10) Pub. No.: US 2026/0189536 A1
(43) Pub. Date: Jul. 2, 2026

(54) SECURE EXECUTION OF AN AI MODEL ON A NEURAL PROCESSING UNIT OF A CLIENT DEVICE

(71) Applicant: Microsoft Technology Licensing, LLC, Redmond, WA (US)

(72) Inventors: Itai ROSENBLAT, Atzmon (IL); Roei Shlomo MENASHOF, Netanya (IL); Oren ISTRIN, Tel Aviv (IL)

(21) Appl. No.: 19/005,710

(22) Filed: Dec. 30, 2024

(51) Int. Cl. H04L 9/40; G06F 21/60

(52) U.S. Cl. CPC H04L 63/0428; G06F 21/602; H04L 63/1425; H04L 63/1441

(57) ABSTRACT

Techniques are described herein that are capable of securely executing an AI model on a neural processing unit (NPU) of a client device. The NPU runs the AI model. The NPU encrypts data, which includes an AI prompt, using a cryptographic key. The NPU provides the encrypted data to a cloud-based security service via a utility in an operating system that executes on the computing system. The NPU receives a response indicator from the cloud-based security service via the utility. The response indicator represents a result of an analysis of a decrypted representation of the encrypted data. The response indicator suggests an alternative response in lieu of an AI response, which is received from the AI model as a result of the AI prompt, as a response to the AI prompt. The NPU provides the alternative response as the response to the AI prompt.

### BACKGROUND

Artificial intelligence (AI) models traditionally are executed in a cloud environment (i.e., in the cloud) because the cloud environment often provides substantial computational resources and scalability. Execution of the AI models in the cloud environment often enable seamless updates to the AI models, collaboration across teams, integration with services and application programming interfaces (APIs), and scaling utilization of the computational resources up or down depending on demand, which may result in AI solutions that are relatively efficient and cost-effective.

Despite the advantages of executing an AI model in the cloud, some drawbacks exist in some instances. For example, sensitive information often is transmitted to and stored on remote servers, which may compromise data security and privacy, for example, by increasing the likelihood of a data breach. In another example, the AI model is accessed in the cloud via an Internet connection, and a reduction in stability or speed of the Internet connection may compromise effectiveness and viability of the AI model. In yet another example, interacting with the AI model via the Internet connection increases latency with regard to obtaining a response from the AI model. In still another example, the cost of using the computational resources in the cloud is substantial, even if utilization of the computational resources is scaled according to demand.

### SUMMARY

It may be desirable to execute an AI model on a client device (e.g., a user device). However, doing so traditionally could increase a risk of exposing the AI model to a malicious attack, for example, by enabling an AI prompt that is submitted to the AI model and/or an AI response that is received from the AI model as a result of the AI prompt to be accessed by a malicious entity. To protect against such a malicious attack, the AI model is run on a neural processing unit of the client device; interactions with the AI model (e.g., the AI prompt, the AI response, and/or corresponding contextual information) are encrypted; and the resulting encrypted interactions are provided to a cloud-based security service for analysis to determine whether the AI response is to be provided to an entity from which the AI prompt is received. In an example, performing such operations hinders (e.g., prevents) the malicious attack, for instance, by hindering (e.g., preventing) the malicious entity from accessing the AI model and/or the interactions with the AI model.

Various approaches are described herein for, among other things, securely executing an AI model on a neural processing unit of a client device. In an example approach, the neural processing unit runs the AI model. The neural processing unit encrypts AI interaction data, which includes an AI prompt, using a cryptographic key to provide encrypted AI interaction data. The neural processing unit provides the encrypted AI interaction data to a cloud-based security service via a utility in an operating system that executes on the computing system. The neural processing unit receives a response indicator from the cloud-based security service via the utility in the operating system. The response indicator represents a result of an analysis of a decrypted representation of the encrypted AI interaction data. The analysis includes a security analysis and/or a sensitivity analysis. The response indicator suggests an alternative response in lieu of an AI response, which is received from the AI model as a result of the AI prompt being processed, as a response to the AI prompt. As a result of the response indicator suggesting the alternative response in lieu of the AI response as the response to the AI prompt, the neural processing unit provides the alternative response in lieu of the AI response as the response to the AI prompt.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURESE

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example NPU-based AI system in accordance with an embodiment.

FIG. 2 is an example activity diagram for securely executing an AI model on a neural processing unit of a client device in accordance with an embodiment.

FIGS. 3-4 depict flowcharts of example methods for securely executing an AI model on a neural processing unit of a client device in accordance with embodiments.

FIG. 5 is a block diagram of an example computing system in accordance with an embodiment.

FIG. 6 is a system diagram of an example mobile device in accordance with an embodiment.

FIG. 7 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Example Embodiments

It may be desirable to execute an AI model on a client device (e.g., a user device).

However, doing so traditionally could increase a risk of exposing the AI model to a malicious attack, for example, by enabling an AI prompt that is submitted to the AI model and/or an AI response that is received from the AI model as a result of the AI prompt to be accessed by a malicious entity. To protect against such a malicious attack, the AI model is run on a neural processing unit of the client device; interactions with the AI model (e.g., the AI prompt, the AI response, and/or corresponding contextual information) are encrypted; and the resulting encrypted interactions are provided to a cloud-based security service for analysis to determine whether the AI response is to be provided to an entity from which the AI prompt is received. In an example, performing such operations hinders (e.g., prevents) the malicious attack, for instance, by hindering (e.g., preventing) the malicious entity from accessing the AI model and/or the interactions with the AI model.

Artificial intelligence (AI) is intelligence of a machine (e.g., a computing system) and/or code (e.g., software and/or firmware), as opposed to intelligence of a living creature (e.g., a human). An AI prompt indicates (e.g., specifies) a task that is to be performed by an AI model. Examples of an AI prompt include but are not limited to a zero-shot prompt, a one-shot prompt, and a few-shot prompt. A zero-shot prompt is a prompt for which the prompt and/or its corresponding contextual information, which are to be processed by the AI model, is not included in pre-trained knowledge of the AI model. A one-shot prompt is a prompt that includes a target prompt along with a single example prompt and a single example answer that is responsive to the single example prompt. The example prompt and the example answer provide guidance as to how the AI model is expected to respond to the target prompt. A few-shot prompt is a prompt that includes a target prompt along with multiple example prompts and multiple example answers that are responsive to the respective example prompts. The example prompts and the example answers provide guidance as to how the AI model is expected to respond to the target prompt.

An AI prompt may be a natural language prompt. A natural language prompt is a prompt that is written in a natural language. A natural language is a human language that has developed through use and repetition. For instance, the natural language may have developed naturally without conscious planning or premeditation. Examples of a natural language include English, French, Spanish, and Mandarin. In an aspect, the natural language prompt is generated by a user (e.g., a human). In another aspect, the natural language prompt is generated by a computing system (e.g., an AI assistant that runs on the computing system).

An AI prompt need not necessarily be written in a natural language. In an example, the AI prompt includes (e.g., is) computer code. In another example, the AI prompt is any suitable sequence of characters that is capable of being interpreted by an AI model.

An AI model is a model that utilizes artificial intelligence to generate an answer that is responsive to an AI prompt (a.k.a. prompt) that is received by the AI model. In an example, the AI model is an artificial general intelligence model. An artificial general intelligence model is an AI model (e.g., an autonomous AI model) that is configured to be capable of performing any task that an intelligent being (e.g., a human) is capable of performing. In an example implementation, the artificial general intelligence model is capable of performing a task that surpasses the capabilities of an animal.

A cyberattack (a.k.a. attack or malicious attack) is an attempt to cause harm to a system and/or to a user of the system. Examples of a cyberattack include but are not limited to a jailbreak attack, a denial of service (DoS) attack, a distributed DoS (DDoS) attack, a man-in-the-middle (MITM) attack, a malware attack, a phishing attack, a ransomware attack, and a cross-site scripting (XSS) attack. A jailbreak attack is an attack that manipulates (or attempts to manipulate) an AI model to perform operations that are outside ethical guidelines or an intended use of the AI model. In an example, the jailbreak attack causes the AI model to generate undesirable (e.g., harmful) content, bypass content filter(s), or execute malicious instructions. In another example, the jailbreak attack enables an AI prompt that is submitted to the AI model and/or an AI response that is received from the AI model as a result of the AI prompt to be accessed by a malicious entity. A DoS attack is an attack that renders a system unable to respond to a legitimate service request by overwhelming resource(s) of the system. A DDoS attack is similar to a DoS attack but involves multiple (e.g., a vast array) malware-infected hosts that are controlled by the threat actor to cause resource exhaustion. An MITM attack is an attack that enables the threat actor to eavesdrop on data exchanged between multiple entities (e.g., people, networks, or computers). A malware attack is an attack in which malicious software is introduced (e.g., injected) to a system to damage the system and/or to steal information from the system. A phishing attack is an attack in which a deceptive communication (e.g., an electronic mail (a.k.a. email) message) is provided to an entity to trick the entity into revealing sensitive information or into downloading malware. A ransomware attack is an attack that encrypts file(s) and/or system(s) and demands payment (a.k.a. a ransom) for decryption. An XSS attack exploits a vulnerability of a web application to introduce a malicious script into a web page that is viewed by other users.

Example embodiments described herein are capable of securely executing an AI model on a neural processing unit of a client device. In an example approach, the neural processing unit runs the AI model. The neural processing unit encrypts AI interaction data, which includes an AI prompt, using a cryptographic key to provide encrypted AI interaction data. The neural processing unit provides the encrypted AI interaction data to a cloud-based security service via a utility in an operating system that executes on the computing system. The neural processing unit receives a response indicator from the cloud-based security service via the utility in the operating system. The response indicator represents a result of an analysis of a decrypted representation of the encrypted AI interaction data. The analysis includes a security analysis and/or a sensitivity analysis. The response indicator suggests an alternative response in lieu of an AI response, which is received from the AI model as a result of the AI prompt being processed, as a response to the AI prompt. As a result of the response indicator suggesting the alternative response in lieu of the AI response as the response to the AI prompt, the neural processing unit provides the alternative response in lieu of the AI response as the response to the AI prompt.

Example techniques described herein have a variety of benefits as compared to conventional techniques for executing an AI model. For instance, the example techniques are capable of reducing an amount of time and/or resources (e.g., processor cycles, memory, network bandwidth) that is consumed to interact with the AI model (e.g., to provide an AI prompt to the AI model and/or to obtain a corresponding AI response from the AI model). In an example, by executing the AI model on a neural processing unit of a client device, the example techniques reduce the amount of time and/or resources that otherwise would have been consumed to interact with the AI model in a cloud environment. In an example, by reducing the amount of time and/or resources that is consumed to interact with the AI model, the example techniques reduce the amount of time and/or resources that is consumed to determine whether the AI response is to be provided as a response to an AI prompt (e.g., to an entity from which the AI prompt is received).

In some example embodiments, the example techniques automate determining whether an AI response that is received from the AI model is to be provided as a response to an AI prompt on which the AI response is based (e.g., by providing the AI prompt, the AI response, and/or contextual information associated with the AI prompt to a cloud-based security service for analysis).

In an example, by reducing the amount of time and/or resources that is consumed by a computing system to interact with an AI model and/or to determine whether an AI response that is received from the AI model is to be provided as a response to an AI prompt on which the AI response is based, the efficiency of the computing system is increased, the speed with which interactions with the AI model occur is increased, and/or a latency associated with the interactions is reduced.

In another example, by reducing the amount of time that is consumed to interact with an AI model and/or to determine whether an AI response that is received from the AI model is to be provided as a response to an AI prompt on which the AI response is based, the example techniques increase a user experience and/or efficiency of a security professional who manages security of a computing system that includes a neural processing unit on which the AI model runs and/or an entity from which the AI prompt is received. In yet another example, the example techniques reduce a number of tasks that are manually performed by the security professional to determine whether the AI response is to be provided as the response to the AI prompt and/or to determine an alternative response that is to be provided in lieu of the AI response. In still another example, the example techniques increase a user experience and/or efficiency of an end user who utilizes the AI model (e.g., who provides the AI prompt to the AI model and/or receives the response to the AI prompt). In some example embodiments, the user experience and/or the efficiency of the security professional and/or the end user is increased in other ways, as well. In an example, the user experience and/or the efficiency is increased through a more accurate, precise, and/or reliable determination whether the AI response is to be provided as the response to the AI prompt and/or a more accurate, precise, and/or reliable determination of an alternative response that is to be provided in lieu of the AI response as the response to the AI prompt (e.g., by providing the AI prompt, the AI response, and/or contextual information associated with the AI prompt to a cloud-based security service for analysis).

By executing the AI model on a neural processing unit of a client device, the example techniques are capable of providing any one or more of the benefits described herein while maintaining security of the AI model and/or interactions with the AI model. In an example, executing the AI model on the neural processing unit of the client device reduces an extent to which cloud-based resources are consumed (e.g., by eliminating a need to consume such cloud-based resources to execute the AI model), which may reduce (e.g., substantially reduce) a cost associated with executing the AI model. In another example, encrypting AI interaction data (e.g., an AI prompt that is to be processed by the AI model, an AI response that results from the AI model processing the AI prompt, and/or contextual information associated with the AI prompt), utilizing the resulting encrypted AI interaction data, using a utility in an operating system that executes on the client device to transfer encrypted communications (e.g., the encrypted AI interaction data) between the neural processing unit and a cloud-based security service, and/or utilizing the cloud-based security service to determine whether the AI response is to be provided as the response to the AI prompt (and/or to determine an alternative response that is to be provided in lieu of the AI response) increases security of the AI model, the neural processing unit, and/or the client device.

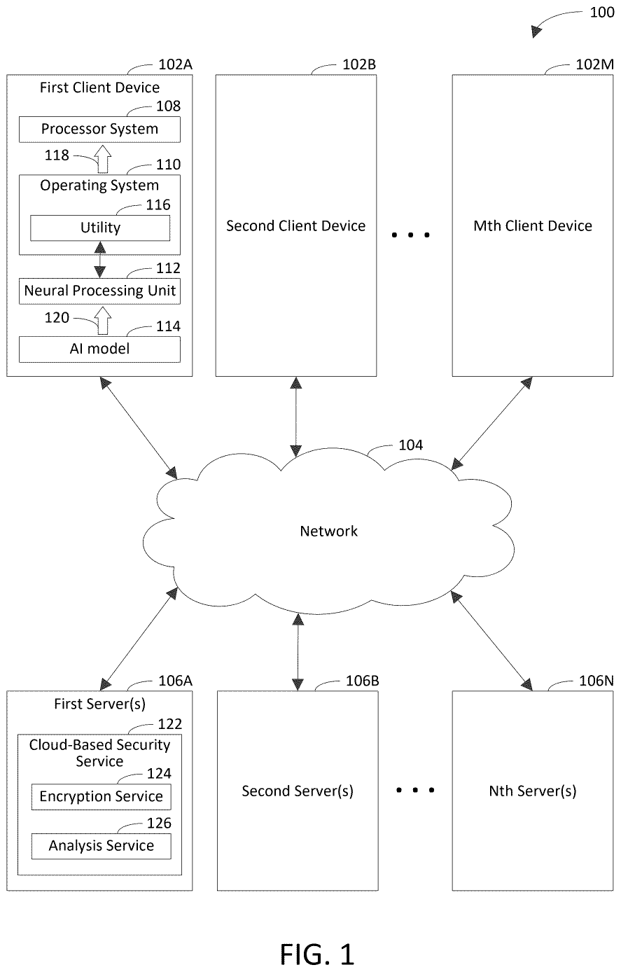

FIG. 1 is a block diagram of an example NPU-based AI system 100 in accordance with an embodiment. Generally speaking, the NPU-based AI system 100 operates to provide information to users in response to requests (e.g., hypertext transfer protocol (HTTP) requests) that are received from the users. In an example, the information includes documents (Web pages, images, audio files, video files, etc.), output of executables, and/or any other suitable type of information. In accordance with example embodiments described herein, the NPU-based AI system 100 enables secure execution of an AI model 114 on a neural processing unit 112 of a first client device 102A. Detail regarding techniques for securely executing an AI model on a neural processing unit of a client device is provided in the following discussion.

As shown in FIG. 1, the NPU-based AI system 100 includes a plurality of client devices 102A-102M, a network 104, and a plurality of servers 106A-106N. Communication among the client devices 102A-102M and the servers 106A-106N is carried out over the network 104 using well-known network communication protocols. In an example, the network 104 is a wide-area network (e.g., the Internet), a local area network (LAN), another type of network, or a combination thereof.

The client devices 102A-102M are computing systems that are capable of communicating with servers 106A-106N. A computing system is a system that includes at least a portion of a processor system such that the portion of the processor system includes at least one processor that is capable of manipulating data in accordance with a set of instructions. A processor system includes one or more processors, which may be on a same (e.g., single) device or distributed among multiple (e.g., separate) devices. Examples of a computing system include but are not limited to a computer and a personal digital assistant. The client devices 102A-102M are configured to provide requests to the servers 106A-106N for requesting information stored on (or otherwise accessible via) the servers 106A-106N. In an example, a user initiates a request for executing a computer program (e.g., an application) using a client (e.g., a Web browser, Web crawler, or other type of client) deployed on a client device 102 that is owned by or otherwise accessible to the user. In accordance with some example embodiments, the client devices 102A-102M are capable of accessing domains (e.g., Web sites) hosted by the servers 106A-106N, so that the client devices 102A-102M may access information that is available via the domains. In an example, such domain includes Web pages, which may be provided as hypertext markup language (HTML) documents and objects (e.g., files) that are linked therein, for example.

Each of the client devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the client devices 102A-102M may communicate with any one or more of the servers 106A-106N.

The first client device 102A is shown to include a processor system 108 and the neural processing unit 112 for illustrative purposes. The processor system 108 executes an operating system 110, as indicated by arrow 118. The operating system 110 is configured to perform operations, which may include managing computer hardware and software resources and providing services for computer programs on the first computing device 102A. Examples of an operating system include but are not limited to a Berkeley Software Distribution™ (BSD) operating system, developed and distributed by the Computer Systems Research Group (CSRG) of the University of California, Berkeley, or descendants thereof; a Linux operating system, developed and distributed under the GNU Project; an iOS™ operating system, developed and distributed by Apple Inc.; a Microsoft Windows® operating system, developed and distributed by Microsoft Corporation; and a UNIX™ operating system, developed and distributed by AT&T. The operating system 110 includes a utility 116. The utility 116 is configured to transfer encrypted communications between the neural processing unit 112 and a cloud-based security service 122.

The neural processing unit 112 executes the AI model 114, as indicated by arrow 120. The AI model is configured to generate an AI response by processing an AI prompt. In an example implementation, the neural processing unit 112 encrypts AI interaction data, which includes the AI prompt, using a cryptographic key to provide encrypted AI interaction data. The neural processing unit 112 provides the encrypted AI interaction data to the cloud-based security service 122 via the utility 116 in the operating system 110. The neural processing unit 112 receives a response indicator from the cloud-based security service 112 via the utility 116 in the operating system 110. The response indicator represents a result of an analysis of a decrypted representation of the encrypted AI interaction data. The analysis includes a security analysis and/or a sensitivity analysis.

A security analysis is an analysis that is configured to identify and/or evaluate a threat, vulnerability, and/or risk to security of a system and/or a user of the system. Examples of a system include but are not limited to a computing system (e.g., a component of the computing system or data stored on, generated by, or used by the computing system) or an AI model. In an example, the data includes (e.g., is) a secret. Examples of a secret include but are not limited to a certificate, a configuration setting, a token, a cryptographic key, and a credential. Examples of a cryptographic key include but are not limited to an application programming interface (API) key, a secure shell (SSH) key, an encryption key, and a decryption key. A cryptographic key may be an asymmetric key (e.g., a private key or a public key) or a symmetric key. Examples of a credential include but are not limited to a username, a password, and a personal identification number (PIN).

A sensitivity analysis is an analysis that is configured to identify harmful and/or offensive content in information. Harmful content is content that is objectively (e.g., statistically) likely to be harmful to a recipient of the content. In an example implementation, harmful content is defined as content having a likelihood that is greater than or equal to a likelihood threshold (e.g., 51%, 75%, or 83%) to cause harm to the recipient. Offensive content is content that is objectively (e.g., statistically) likely to be offensive to a recipient of the content. In an example implementation, offensive content is defined as content having a likelihood that is greater than or equal to a likelihood threshold (e.g., 56%, 82%, or 90%) to offend the recipient. In an example, harmful and/or offensive content includes (e.g., depicts, describes, or shows) violence, hate speech, and/or sexual content (e.g., sexual imagery).

The response indicator indicates whether an alternative response is to be provided in lieu of an AI response, which is received from the AI model 114 as a result of the AI prompt being processed, as a response to the AI prompt. In a first example implementation, as a result of the response indicator indicating that the alternative response is to be provided in lieu of the AI response as the response to the AI prompt, the neural processing unit 112 provides the alternative response in lieu of the AI response as the response to the AI prompt. In a second example implementation, as a result of the response indicator indicating that the AI response is to be provided as the response to the AI prompt, the neural processing unit 112 provides the AI response as the response to the AI prompt.

The processor system 108 and the neural processing unit 112 are shown to be incorporated in the first client device 102A for illustrative purposes and are not intended to be limiting. It will be recognized that the processor system 108 and/or the neural processing unit 112 (or any portion(s) thereof) may be incorporated in any one or more of the client devices 102A-102M.

The servers 106A-106N are computing systems that are capable of communicating with the client devices 102A-102M. The servers 106A-106N are configured to execute computer programs that provide information to users in response to receiving requests from the users. In an example, the information includes documents (Web pages, images, audio files, video files, etc.), output of executables, or any other suitable type of information. In accordance with some example embodiments, the servers 106A-106N are configured to host respective Web sites, so that the Web sites are accessible to users of the NPU-based AI system 100.

The first server(s) 106A are shown to include the cloud-based security service 122 for illustrative purposes. The cloud-based security service 122 is configured to perform the analysis of the decrypted representation of the encrypted AI interaction data that is received from the neural processing unit 112 via the utility 116 to determine whether the AI response, which is generated by the AI model 114 by processing the AI prompt, is to be provided as the response to the AI prompt (e.g., to a user of the first client device 102A). The cloud-based security service 122 includes an encryption service 124 and an analysis service 126. The encryption service 124 decrypts the encrypted AI interaction data to provide the decrypted representation of the encrypted AI interaction data.

The analysis service 126 performs the analysis of the decrypted representation of the encrypted AI interaction data. The analysis includes determining whether the AI response, which is generated by the AI model 114, is to be provided as the response to the AI prompt. The analysis service 126 generates a response indicator based on the analysis. The response indicator indicates whether the alternative response is to be provided in lieu of the AI response as the response to the AI prompt. In the first example implementation mentioned above with reference to the neural processing unit 112, the analysis service 126 configures the response indicator to indicate that the alternative response is to be provided in lieu of the AI response as the response to the AI prompt. In the second example implementation mentioned above with reference to the neural processing unit 112, the analysis service 126 configures the response indicator to indicate that the AI response is to be provided as the response to the AI prompt. The analysis service 126 provides the analysis indicator to the neural processing unit 112 via the utility 116. In an example embodiment, the encryption service 124 encrypts the response indicator prior to the response indicator being provided to the neural processing unit 112. In accordance with this embodiment, the neural processing unit 112 decrypts the response indicator upon receipt.

In some example embodiments, the cloud-based security service 122 is (or is included in) a computer security program and/or a cloud computing program. A computer security program is a computer program that provides security with regard to information and/or communications associated with a computing system. In an example, the information associated with the computing system includes information stored on the computing system and/or information accessed (e.g., read) by the computing system. In another example, the communications associated with the computing system include communications received by the computing system and/or communications provided (e.g., transmitted) by the computing system. An example of a communication is an electronic message. Examples of a computer security program include Bitdefender® security program, developed and distributed by Bitdefender IPR Management Ltd.; Norton® security program, developed and distributed by Gen Digital Inc.; Avast® security program, developed and distributed by Avast Software S.R.O.; McAfee® security program, developed and distributed by McAfee, LLC; and Microsoft Defender® security program, developed and distributed by Microsoft Corporation. It will be recognized that at least some aspects of the example techniques described herein may be implemented using a computer security program. In an example, a software product (e.g., a subscription service, a non-subscription service, or a combination thereof) includes the computer security program, and the software product is configured to perform at least some aspects of the example techniques.

A computer security program may be incorporated into a cloud computing program (a.k.a. a cloud service). A cloud computing program is a computer program that provides hosted service(s) via a network (e.g., network 104). In an example, the hosted service(s) are hosted by any one or more of the servers 106A-106N. In another example, the cloud computing program enables users (e.g., at any of the user systems 102A-102M) to access shared resources that are stored on or are otherwise accessible to the server(s) via the network.

The cloud computing program may provide hosted service(s) according to any of a variety of service models, including but not limited to Backend as a Service (BaaS), Software as a Service (SaaS), Platform as a Service (PaaS), and Infrastructure as a Service (IaaS). BaaS enables applications (e.g., software programs) to use a BaaS provider's backend services (e.g., push notifications, integration with social networks, and cloud storage) running on a cloud infrastructure. SaaS enables a user to use a SaaS provider's applications running on a cloud infrastructure. PaaS enables a user to develop and run applications using a PaaS provider's application development environment (e.g., operating system, programming-language execution environment, database) on a cloud infrastructure. IaaS enables a user to use an IaaS provider's computer infrastructure (e.g., to support an enterprise). In an example, IaaS provides to the user virtualized computing resources that utilize the IaaS provider's physical computer resources.

Examples of a cloud computing program include but are not limited to a Google Cloud® program developed and distributed by Google Inc.; an Oracle Cloud® program developed and distributed by Oracle Corporation; an Amazon Web Services® program developed and distributed by Amazon.com, Inc.; a Salesforce® program developed and distributed by Salesforce.com, Inc.; an AppSource® program developed and distributed by Microsoft Corporation; an Azure® program developed and distributed by Microsoft Corporation; a GoDaddy® program developed and distributed by GoDaddy.com LLC; and a Rackspace® program developed and distributed by Rackspace US, Inc. It will be recognized that at least some aspects of the example techniques described herein may be implemented using a cloud computing program. In an example, a software product (e.g., a subscription service, a non-subscription service, or a combination thereof) includes the cloud computing program, and the software product is configured to perform at least some aspects of the example techniques.

The cloud-based security service 122 (e.g., the encryption service 124 and/or the analysis service 126) is shown to be incorporated in the first server(s) 106A for illustrative purposes and is not intended to be limiting. It will be recognized that the cloud-based security service 122 (e.g., the encryption service 124 and/or the analysis service 126) (or any portion(s) thereof) may be incorporated in any one or more of the servers 106A-106N.

The processor system 108, the neural processing unit 112, and/or the cloud-based security service 122 (e.g., the encryption service 124 and/or the analysis service 126) may be implemented in various ways to perform the operations described herein, including being implemented in hardware, software, firmware, or any combination thereof. In an example, the processor system 108, the neural processing unit 112, and/or the cloud-based security service 122 (e.g., the encryption service 124 and/or the analysis service 126) is implemented as computer program code configured to be executed in one or more processors. In another example, at least a portion of the processor system 108, the neural processing unit 112, and/or the cloud-based security service 122 (e.g., the encryption service 124 and/or the analysis service 126) is implemented as hardware logic/electrical circuitry. In an aspect, at least a portion of the processor system 108, the neural processing unit 112, and/or the cloud-based security service 122 (e.g., the encryption service 124 and/or the analysis service 126) is implemented in a field-programmable gate array (FPGA), an application-specific integrated circuit (ASIC), an application-specific standard product (ASSP), a system-on-a-chip system (SoC), a complex programmable logic device (CPLD), etc. In an example, each SoC includes an integrated circuit chip that includes one or more of a processor (a microcontroller, microprocessor, digital signal processor (DSP), etc.), memory, one or more communication interfaces, and/or further circuits and/or embedded firmware to perform its functions.

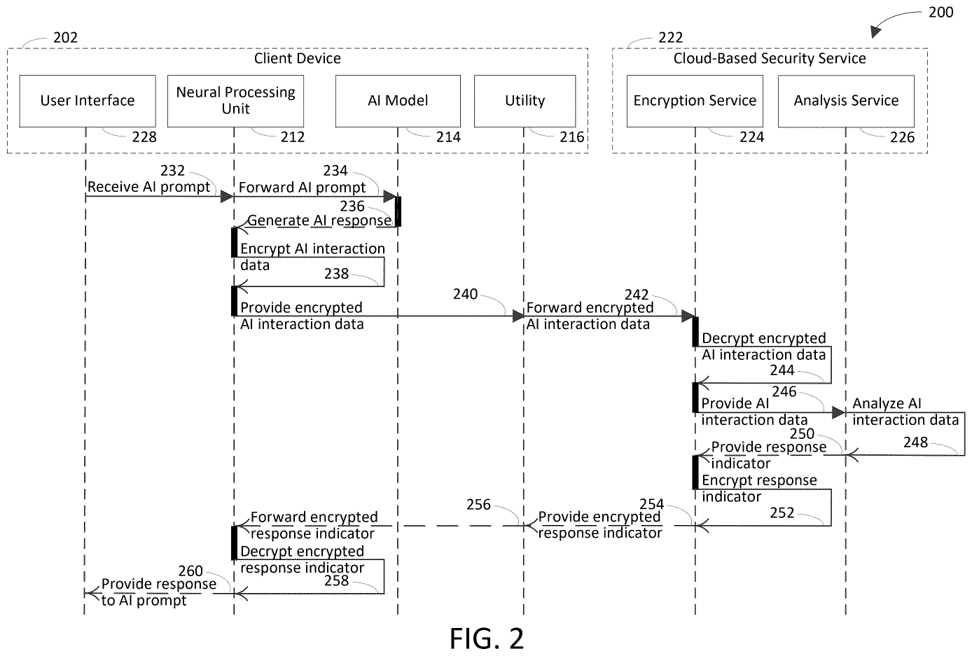

FIG. 2 is an example activity diagram 200 for securely executing an AI model on a neural processing unit of a client device in accordance with an embodiment. FIG. 2 depicts a client device 202 and a cloud-based security service 222. The client device includes a user interface 228, a neural processing unit 212, an AI model 214, and a utility 216. The cloud-based security service 222 includes an encryption service 224 and an analysis service 226. Activities 232, 234, 236, 238, 240, 242, 244, 246, 248, 250, 252, 254, 256, 258, and 260 will now be described with reference to the user interface 228, the neural processing unit 212, the AI model 214, the utility 216, the encryption service 224 and the analysis service 226.

In activity 232, the neural processing unit 212 receives an AI prompt from the user interface 228. In an example, the user interface 228 receives the AI prompt from a user of the client device 202 and passes the AI prompt to the neural processing unit 212. In an example embodiment, the AI prompt is directed toward the AI model 214. In accordance with this embodiment, the neural processing unit 212 intercepts the AI prompt as the AI prompt travels from the user interface 228 toward the AI model 214.

In activity 234, the neural processing unit 212 forwards the AI prompt to the AI model 214.

In activity 236, the AI model 214 generates an AI response that is based on (e.g., based at least on) the AI prompt. In an example, receipt of the AI prompt at the AI model 214 from the neural processing unit 212 triggers the AI model 214 to generate the AI response. In an aspect, the AI model 214 analyzes the AI prompt to identify an inquiry therein, gathers information that is relevant to answering the inquiry, and generates the AI response to include an answer to the query. In accordance with this aspect, the AI model 214 derives the answer from the information.

In activity 238, the neural processing unit 212 generates encrypted AI interaction data by encrypting AI interaction data. The AI interaction data includes the AI prompt, the AI response, and/or contextual information that includes context regarding the AI prompt. For instance, the neural processing unit 212 may have provided the contextual information together with the AI prompt as inputs to the AI model 214 in activity 234.

In activity 240, the neural processing unit 212 provides the encrypted AI interaction data to the utility 216 for transmission to the cloud-based security service 222.

In activity 242, the utility 216 forwards the encrypted AI interaction data to the encryption service 224 of the cloud-based security service 222.

In activity 244, the encryption service 224 decrypts the encrypted AI interaction data to gain access to the AI interaction data.

In activity 246, the encryption service 224 provides the AI interaction data to the analysis service 226 of the cloud-based security service 222.

In activity 248, the analysis service 226 analyzes the AI interaction data to determine whether the AI response is to be provided as a response to the AI prompt (e.g., to a user of the client device 202 via the user interface 228). In an aspect, the analysis includes a security analysis and/or a sensitivity analysis.

In activity 250, the analysis service 226 provides a response indicator to the encryption service 224. The response indicator indicates (e.g., specifies) whether the AI response is to be provided as the response to the AI prompt.

In activity 252, the encryption service 224 generates an encrypted response indicator by encrypting the response indicator.

In activity 254, the encryption service 224 provides the encrypted response indicator to the utility 216.

In activity 256, the utility 216 forwards the encrypted response indicator to the neural processing unit 212.

In activity 258, the neural processing unit 212 decrypts the encrypted response indicator to gain access to the response indicator.

In activity 260, the neural processing unit 212 provides the response to the AI prompt to the user interface 228. The neural processing unit 212 selects the AI response or an alternative response to be the response to the AI prompt based on the response indicator. For example, if the response indicator indicates that the AI response is to be provided as the response to the AI prompt, the neural processing unit 212 provides the AI response as the response to the AI prompt to the user interface 228. In another example, if the response indicator indicates that the alternative response is to be provided in lieu of the AI response as the response to the AI prompt, the neural processing unit 212 provides the alternative response as the response to the AI prompt to the user interface 228.

In some example embodiments, one or more of the activities 232, 234, 236, 238, 240, 242, 244, 246, 248, 250, 252, 254, 256, 258, and/or 260 of the activity diagram 200 are not performed. Moreover, in some example embodiments, activities in addition to or in lieu of the activities 232, 234, 236, 238, 240, 242, 244, 246, 248, 250, 252, 254, 256, 258, and/or 260 are performed.

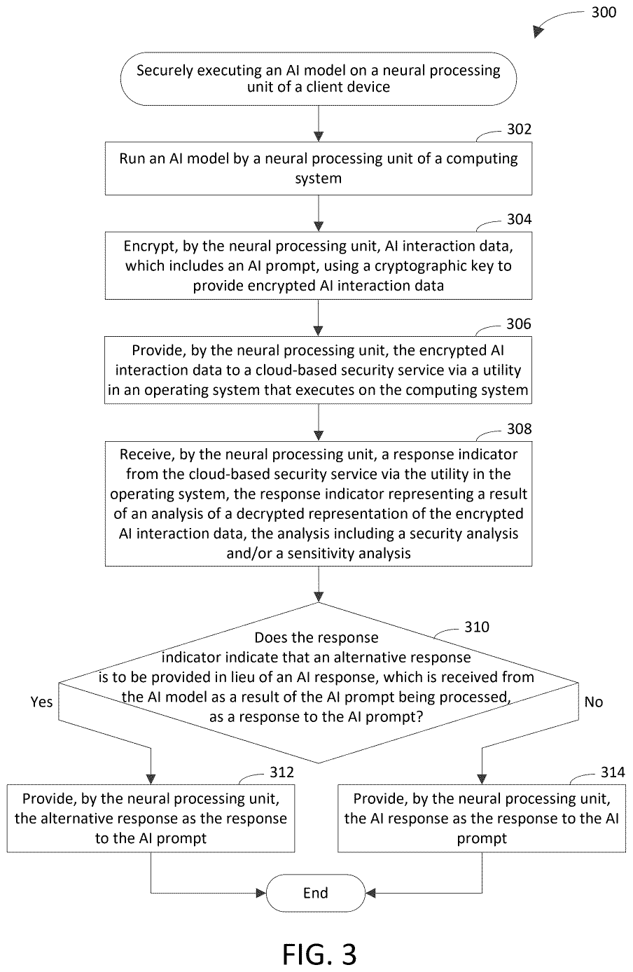

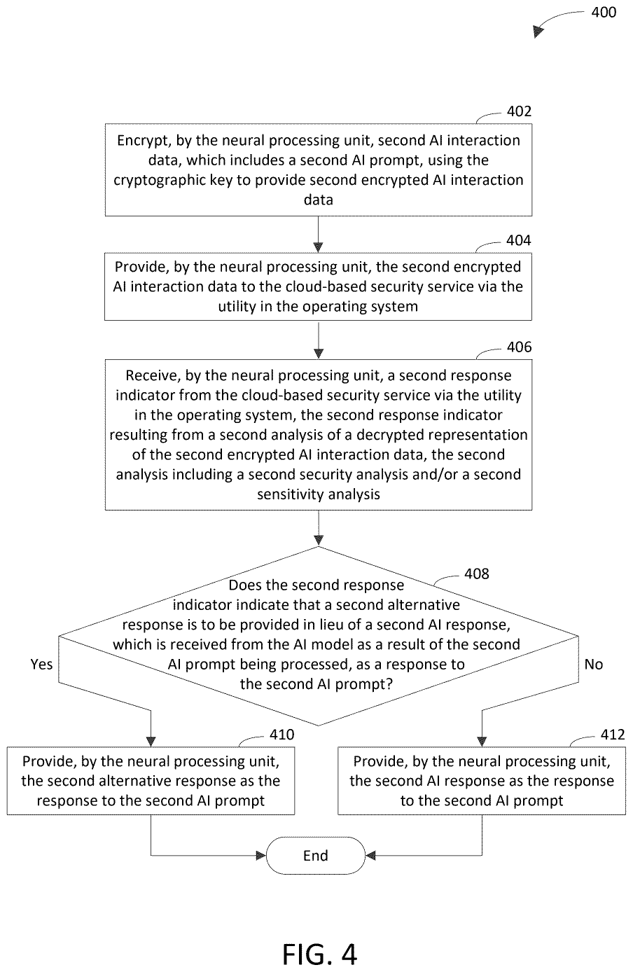

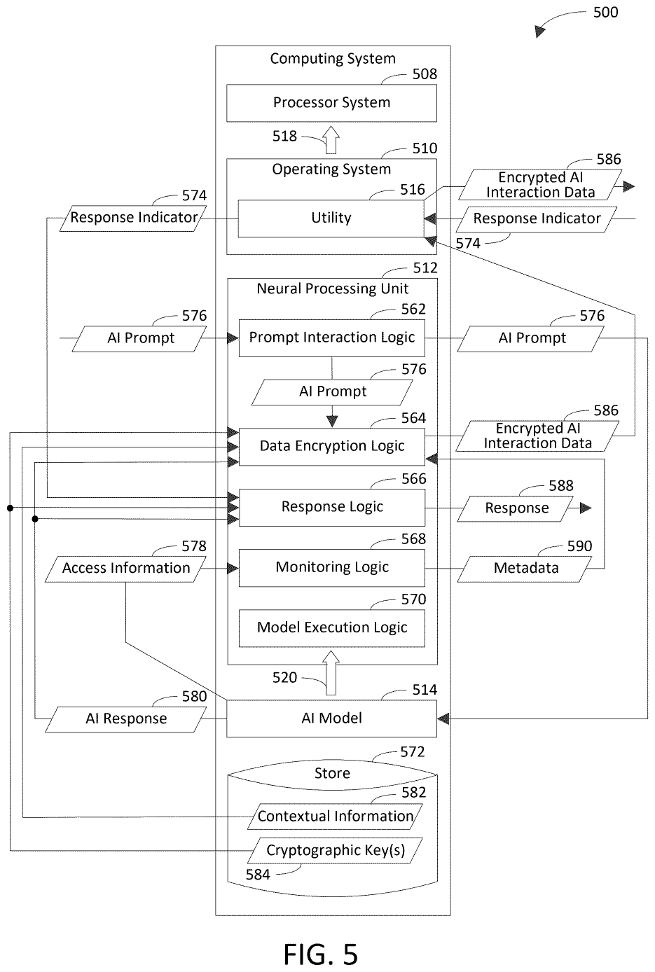

FIGS. 3-4 depict flowcharts 300 and 400 of example methods for securely executing an AI model on a neural processing unit of a client device in accordance with embodiments. In an example, flowcharts 300 and 400 are performed by the first client device 102A (e.g., the neural processing unit 112 therein) shown in FIG. 1. For illustrative purposes, flowcharts 300 and 400 are described with respect to a computing system 500 shown in FIG. 5, which is an example implementation of the first client device 102A. As shown in FIG. 5, the computing system 500 includes a processor system 508, a neural processing unit 512, and a store 572. The processor system 508 executes an operating system 510, which includes a utility 516, as indicated by arrow 518. The neural processing unit 512 includes prompt interaction logic 562, data encryption logic 564, response logic 566, monitoring logic 568, and model execution logic 570. The model execution logic 570 executes an AI model 514, as indicated by arrow 520. The store 572 may be any suitable type of store. One type of store is a database. For instance, the store 572 may be a relational database, an entity-relationship database, an object database, an object relational database, an extensible markup language (XML) database, etc. The store 572 is shown to store contextual information 582 and cryptographic key(s) 584 for non-limiting, illustrative purposes. Further structural and operational embodiments will be apparent to persons skilled in the relevant art(s) based on the discussion regarding flowcharts 300 and 400.

As shown in FIG. 3, the method of flowchart 300 begins at step 302. In step 302, an AI model is run by a neural processing unit. In an example implementation, the neural processing unit 512 (e.g., the model execution logic 570 therein) runs the AI model 514.

At step 304, AI interaction data is encrypted by the neural processing unit using a cryptographic key to provide encrypted AI interaction data. The AI interaction data includes an AI prompt (e.g., that is to be processed by the AI model). In an example embodiment, the AI interaction data further includes an AI response, which is received from the AI model as a result of the AI prompt being processed by the AI model. In another example embodiment, the AI interaction data further includes contextual information, which includes context regarding the AI prompt. In an example, each of the AI prompt, the AI response, and the contextual information includes any suitable type of information, including but not limited to text, media, and code. Examples of media include but are not limited to a still image, a video, and an audio file. Examples of a still image include but are not limited to a photograph and a drawing. In an aspect, the AI prompt is multi-modal, meaning that the AI prompt includes at least two types of information (e.g., text and media; media and code; text and code; or text, media, and code). In another aspect, the AI response is multi-modal. In yet another aspect, the contextual information is multi-modal. In an example, the cryptographic key is a symmetric key. In another example, the cryptographic key is an asymmetric key.

In an example implementation, the data encryption logic 564 encrypts AI interaction data using a cryptographic key, which is included in the cryptographic key(s) 584, to provide encrypted AI interaction data 586. The AI interaction data includes an AI prompt 576 (e.g., that is to be processed by the AI model 514). In an aspect, the prompt interaction logic 562 intercepts the AI prompt 576 as the AI prompt 576 is being transferred to the AI model 514 and provides the AI prompt 576 to the data encryption logic 564 for encryption. In another aspect, the AI interaction data further includes an AI response 580, which is received from the AI model 514 as a result of the AI prompt 576 being processed by the AI model 514, and/or contextual information 582, which includes context regarding the AI prompt 576.

At step 306, the encrypted AI interaction data is provided by the neural processing unit to a cloud-based security service via a utility in an operating system that executes on the computing system. In an example implementation, the data encryption logic 564 provides the encrypted AI interaction data 586 to the cloud-based security service via the utility 516 in the operating system 510. In an example, the data encryption logic 564 causes (e.g., triggers) the utility 516 to forward (e.g., automatically forward) the encrypted AI interaction data 586 to the cloud-based security service by providing the encrypted AI interaction data 586 to the utility 516.

At step 308, a response indicator is received by the neural processing unit from the cloud-based security service via the utility in the operating system. The response indicator represents a result of an analysis of a decrypted representation of the encrypted AI interaction data. The analysis includes a security analysis and/or a sensitivity analysis. In an example implementation, the response logic 566 receives a response indicator 574 from the cloud-based security service via the utility 516 in the operating system 510. The response indicator 574 represents a result of an analysis of a decrypted representation of the encrypted AI interaction data 586, which includes a security analysis and/or a sensitivity analysis.

At step 310, a determination is made whether the response indicator indicates that an alternative response is to be provided in lieu of an AI response, which is received from the AI model as a result of the AI prompt being processed, as a response to the AI prompt. In an example, the response indicator having a first value indicates that the AI response is to be provided as the response to the AI prompt, and the response indicator having a second value, which is different from the first value, indicates that the alternative response is to be provided as the response to the AI prompt. In an example embodiment, the alternative response is configured to replace a portion of the AI response with a replacement portion (e.g., an obfuscation, such as asterisks or other placeholder). In another example embodiment, the alternative response includes (e.g., is) a statement that indicates a reason that the AI response is not being provided as the response to the AI prompt. In an example implementation, the response logic 566 determines whether the response indicator 574 indicates that the alternative response is to be provided in lieu of an AI response 580 as a response 588 to the AI prompt 576. The AI response 580 is received by the response logic 566 from the AI model 514 as a result of the AI prompt 576 being processed by the AI model 514. In an example embodiment, the response logic 566 determines that the alternative response is to be provided as the response 588 to the AI prompt 576 as a result of the response indicator 574 including the alternative response. In another example embodiment, the response logic 566 determines that the AI response 580 is to be provided as the response 588 to the AI prompt 576 as a result of the response indicator 574 not including the alternative response. If the response indicator indicates that the alternative response is to be provided in lieu of the AI response as the response to the AI prompt, flow continues to step 312. Otherwise, flow continues to step 314.

At step 312, the alternative response is provided as the response to the AI prompt by the neural processing unit. In an aspect, the alternative response is provided in lieu of the AI response as the response to the AI prompt. In an example implementation, the response logic 566 provides the alternative response as the response 588 to the AI prompt 576. Upon completion of step 312, flowchart 300 ends.

In an example embodiment, step 312 includes blocking the AI response from being provided to an entity from which the AI prompt is received by providing the alternative response in lieu of the AI response as the response to the AI prompt. Examples of an entity include but are not limited to a user (e.g., a user of the computing system 500) or a computer program (e.g., an application or a service).

At step 314, the AI response is provided as the response to the AI prompt by the neural processing unit. In an aspect, the AI response is provided in lieu of the alternative response as the response to the AI prompt. In an example implementation, the response logic 566 provides the AI response 580 as the response 588 to the AI prompt 576. Upon completion of step 314, flowchart 300 ends.

In an example embodiment, the neural processing unit utilizes a zero trust architecture to validate, authenticate, and encrypt requests for resources that are received by the neural processing unit. In an example, the requests for the resources are triggered by one or more AI prompts that are provided to the AI model. In an aspect, the AI model triggers the requests for the resources by analyzing the one or more AI prompts to generate one or more corresponding AI responses. Examples of a resource include but are not limited to an account (e.g., a subscription to a service), a virtual machine, a component of a virtual machine (e.g., a virtual processor system, a virtual random access memory (vRAM), or a virtual disk), a physical machine (e.g., a physical computing system), a component of a physical machine (e.g., a physical processor system, a physical random access memory (RAM), or a physical disk), a store (e.g., data storage or a code repository), an identity (e.g., a user identity), a user, a secret, a cluster (e.g., a Kubernetes® cluster), a process running on a machine, a network, a file, a folder, or a resource group (e.g., a collection of resources of a particular type). Accordingly, it will be recognized that a resource may be implemented in software, firmware, hardware, or any combination thereof. A Kubernetes® cluster is a plurality of node machines that are used to run containerized software application(s). In an example, the node machines include one or more physical machines and/or one or more virtual machines. In an aspect, the Kubernetes® cluster automates distribution of the containerized software application(s) across the plurality of node machines, manages scaling and failover, and/or provides deployment patterns and services for managing the containerized software application(s). In an aspect, the computing system, which includes the neural processing unit, utilizes the zero trust architecture to validate, authenticate, and encrypt requests for resources that are received by the computing system.

In another example embodiment, by performing one or more of the techniques described herein, the neural processing unit provides a secure channel that is encrypted in hardware of the neural processing unit without visibility to other components of the computing system that includes the neural processing unit, except for the utility in the operating system, and/or without visibility to a user of the computing system. In an aspect, the secure channel enables transmission of the encrypted AI interaction data from the neural processing unit to the cloud-based security service and transmission of the response indicator from the cloud-based security service to the neural processing unit without other components of the computing system, except for the utility, and/or the user of the computing system having access to the encrypted AI interaction data and/or the response indicator. In another aspect, the neural processing unit provides the secure channel by implementing a zero trust architecture.

In some example embodiments, one or more steps 302, 304, 306, 308, 310, 312, and/or 314 of flowchart 300 are not performed. Moreover, in some example embodiments, steps in addition to or in lieu of steps 302, 304, 306, 308, 310, 312, and/or 314 are performed. For instance, in an example embodiment, the method of flowchart 300 further includes determining, by the neural processing unit, that the AI model accesses a file that includes sensitive information. In an example, the determination includes determining that the AI model accesses the file in which a user (e.g., a user of the computing device 500) has inserted the sensitive information. In another example, the sensitive information includes a certificate, a configuration setting, a token, a cryptographic key, and/or a credential. In an example implementation, the monitoring logic 568 determines that the AI model 514 accesses the file that includes the sensitive information by analyzing access information 578, which indicates file(s) that are accessed by the AI model 514 and/or content of the file(s). In accordance with this embodiment, the AI interaction data that is encrypted at step 304 includes the AI prompt and metadata indicating that the file includes the sensitive information. Accordingly, encrypting the AI interaction data at step 304 includes encrypting the AI interaction data, which includes the AI prompt and the metadata, using the cryptographic key to provide the encrypted AI interaction data. In an example implementation, the monitoring logic 568 generates metadata 590, which indicates that the file includes the sensitive information. In accordance with this implementation, the data encryption logic 564 encrypts the AI interaction data, which includes the AI prompt 576 and the metadata 590, using the cryptographic key to provide the encrypted AI interaction data 586.

In another example embodiment, the method of flowchart 300 further includes, as a result of the response indicator indicating that the alternative response is to be provided in lieu of the AI response as the response to the AI prompt (e.g., as determined at step 310), generating, by the neural processing unit, the alternative response. In an example, the alternative response is generated in accordance with (e.g., to ensure compliance with) a pre-defined policy. Examples of a pre-defined policy include but are not limited to a security policy, a sensitivity policy, and a hybrid policy. An security policy is a policy that is configured to protect against a threat, vulnerability, and/or risk to security of a system and/or a user of the system. In an aspect, the security policy indicates information that is capable of (or potentially capable of) creating (or facilitating creation of) the threat, vulnerability, and/or risk. In accordance with this aspect, the security policy disallows inclusion of the information in the response to the AI prompt. In an example, the security policy ensures that the information is not included in (e.g., is excluded from) response(s) to any one or more AI prompts that are provided to the AI model. A sensitivity policy is a policy that is configured to protect against harmful and/or offensive content in information. In an aspect, the sensitivity policy indicates (e.g., identifies or specifies) the harmful and/or offensive content. In accordance with this aspect, the sensitivity policy disallows inclusion of the harmful and/or offensive content in the response to the AI prompt. In an example, the sensitivity policy ensures that the harmful and/or offensive content is not included in (e.g., is excluded from) response(s) to any one or more AI prompts that are provided to the AI model. A hybrid policy is a combination of a security policy and a sensitivity policy. In another example, the policy is maintained and/or implemented (e.g., enforced) by the utility in the operating system, the cloud-based security service, the neural processing unit, or any combination thereof. In an example implementation, as a result of the response indicator 574 indicating that the alternative response is to be provided in lieu of the AI response 580 as the response to the AI prompt 576, the response logic 566 generates the alternative response. In accordance with this embodiment, the alternative response is provided as the response to the AI prompt at step 312 as a result of the alternative response being generated by the neural processing unit.

In yet another example embodiment, the response indicator that is received from the cloud-based security service at step 308 is encrypted. In accordance with this embodiment, the method of flowchart 300 further includes decrypting, by the neural processing unit, the response indicator using a second cryptographic key. In an example, the second cryptographic key is a symmetric key. In another example, the second cryptographic key is an asymmetric key. The cryptographic key that is used by the neural processing unit to encrypt the AI interaction data at step 304 and the second cryptographic key may be same or different. In an example, the cryptographic key and the second cryptographic key are a common (e.g., same) asymmetric key. In an example implementation, the response logic 566 decrypts the response indicator 574 using a second cryptographic key, which is included in the cryptographic key(s) 584. In accordance with this embodiment, the alternative response is provided as the response to the AI prompt at step 312 as a result of the response indicator being decrypted by the neural processing unit.

In still another example embodiment, the method of flowchart 300 further includes one or more of the steps shown in flowchart 400 of FIG. 4. As shown in FIG. 4, the method of flowchart 400 begins at step 402. In step 402, second AI interaction data, which includes a second AI prompt (e.g., that is to be processed by the AI model), is encrypted by the neural processing unit using the cryptographic key to provide second encrypted AI interaction data. In an example implementation, the data encryption logic 564 encrypts the second AI interaction data using the cryptographic key to provide the second encrypted AI interaction data.

At step 404, the second encrypted AI interaction data is provided by the neural processing unit to the cloud-based security service via the utility in the operating system. In an example implementation, the data encryption logic 564 provides the second encrypted AI interaction data to the cloud-based security service via the utility 516 in the operating system 510.

At step 406, a second response indicator is received by the neural processing unit from the cloud-based security service via the utility in the operating system. The second response indicator represents a result of a second analysis of a decrypted representation of the second encrypted AI interaction data. The second analysis includes a second security analysis and/or a second sensitivity analysis. In an example implementation, the response logic 566 receives the second response indicator from the cloud-based security service via the utility 516 in the operating system 510.

At step 408, a determination is made whether the second response indicator indicates that a second alternative response is to be provided in lieu of a second AI response, which is received from the AI model as a result of the second AI prompt being processed, as a response to the second AI prompt. In an example, the second response indicator having a first value indicates that the second AI response is to be provided as the response to the second AI prompt, and the second response indicator having a second value, which is different from the first value, indicates that the second alternative response is to be provided as the response to the second AI prompt. In an example embodiment, the second alternative response is configured to replace a portion of the second AI response with a replacement portion (e.g., an obfuscation, such as asterisks or other placeholder). In another example embodiment, the second alternative response includes (e.g., is) a statement that indicates a reason that the second AI response is not being provided as the response to the second AI prompt. In an example implementation, the response logic 566 determines whether the second response indicator indicates that the second alternative response is to be provided in lieu of the second AI response as the response to the second AI prompt. The second AI response is received by the response logic 566 from the AI model 514 as a result of the second AI prompt being processed by the AI model 514. In an example embodiment, the response logic 566 determines that the second alternative response is to be provided as the response to the second AI prompt as a result of the second response indicator including the second alternative response. In another example embodiment, the response logic 566 determines that the second AI response is to be provided as the response to the second AI prompt as a result of the second response indicator not including the second alternative response. If the second response indicator indicates that the second alternative response is to be provided in lieu of the second AI response as the response to the second AI prompt, flow continues to step 410. Otherwise, flow continues to step 412.

At step 410, the second alternative response is provided as the response to the second AI prompt by the neural processing unit. In an aspect, the second alternative response is provided in lieu of the second AI response as the response to the second AI prompt. In an example implementation, the response logic 566 provides the second alternative response as the response to the second AI prompt. Upon completion of step 410, flowchart 400 ends.

In an example embodiment, step 410 includes blocking the second AI response from being provided to an entity from which the second AI prompt is received by providing the second alternative response in lieu of the second AI response as the response to the second AI prompt.

At step 412, the second AI response is provided as the response to the second AI prompt by the neural processing unit. In an aspect, the second AI response is provided in lieu of the second alternative response as the response to the second AI prompt. In an example implementation, the response logic 566 provides the second AI response as the response to the second AI prompt. Upon completion of step 412, flowchart 400 ends.

In an aspect, providing the second AI response as the response to the second AI prompt at step 412 includes waiting to enable an entity from which the second AI prompt is received to access (e.g., view) the second AI response until the second response indicator, which indicates that the second AI response is to be provided as the response to the second AI prompt, is received.

In some example embodiments, the prompt interaction logic 562 provides the AI prompt 576 alone or together with contextual information as input(s) to the AI model 514, which causes the AI model 514 to generate the AI response 580. The AI prompt 576 requests completion of a task. The contextual information, if any, includes context regarding the AI prompt 576. In an example, the contextual information includes information regarding a user session that includes the AI prompt 576. A user session is a period of time during which a user remains in continuous dialog with an AI model (e.g., AI model 514). In another example, the user session is defined to start at a time instance at which an initial AI prompt is received from the user. In yet another example, the user session is defined to end based on a designated (e.g., predefined) amount of time passing since a most recent communication between the user and the AI model (e.g., a most recent AI prompt being received from the user or a most recent AI response being generated by the AI model as a result of receiving an AI prompt from the user) during the session without another AI prompt (e.g., another prompt that relates to a task with which previous AI prompt(s) in the user session are associated) being received from the user. In an aspect, the AI model 514 generates the AI response 580 by analyzing the AI prompt 576 and/or the contextual information. In accordance with this aspect, by analyzing the AI prompt 576 and/or the contextual information, the AI model 514 determines relationships between attributes of information in the AI prompt 576 and/or the contextual information.

In an example embodiment, the prompt interaction logic 562 causes (e.g., triggers) the AI model 514 to analyze (e.g., develop and/or refine an understanding of) the AI prompt 576, the contextual information, relationships between any of the foregoing, and confidences in those relationships. In an example, the prompt interaction logic 562 causes the AI model 514 to compare attributes of the AI prompt 576 and the contextual information using artificial intelligence to generate the AI response 580. In another example, the contextual information further includes sample AI prompt(s) and sample AI response(s) to sample AI prompt(s).

In some example embodiments, the AI model 514 includes a neural network that uses the artificial intelligence to determine (e.g., predict) relationships between the AI prompt 514 and the contextual information and confidences in the relationships. The neural network uses those relationships to generate the AI response 580. In an example, attributes of the AI prompt 576, the contextual information, and potentially example AI prompt(s) and example AI response(s) to the sample AI prompt(s) are compared to determine similarities and differences between those attributes. In an aspect, the neural network uses those similarities and differences to generate the AI response 580.

Examples of a neural network include but are not limited to a feed forward neural network and a transformer-based neural network. A feed forward neural network is an artificial neural network for which connections between units in the neural network do not form a cycle. The feed forward neural network allows data to flow forward (e.g., from the input nodes toward to the output nodes), but the feed forward neural network does not allow data to flow backward (e.g., from the output nodes toward to the input nodes). In an example embodiment, the explanation analysis logic 616 employs a feed forward neural network to train the AI model 514, which is used to determine AI-based confidences. In an example, such AI-based confidences are used to determine likelihoods that events will occur.

A transformer-based neural network is a neural network that incorporates a transformer. A transformer is a deep learning model that utilizes attention to differentially weight the significance of each portion of sequential input data, such as natural language. Attention is a technique that mimics cognitive attention. Cognitive attention is a behavioral and cognitive process of selectively concentrating on a discrete aspect of information while ignoring other perceivable aspects of the information. Accordingly, the transformer uses the attention to enhance some portions of the input data while diminishing other portions. The transformer determines which portions of the input data to enhance and which portions of the input data to diminish based on the context of each portion. In an example, the transformer is trained to identify the context of each portion using any suitable technique, such as gradient descent.

In example embodiments, the prompt interaction logic 562 includes training logic, and the AI model 514 includes inference logic. The training logic is configured to train an AI algorithm that the inference logic uses to determine (e.g., infer) the AI-based confidences. In an example, the training logic provides sample AI prompts and sample contextual information as inputs to the AI algorithm to train the AI algorithm. In another example, the sample data are labeled. In yet another example, the AI algorithm is configured to derive relationships between the features (e.g., the AI prompt 514 and the contextual information) and the resulting AI-based confidences. The inference logic is configured to utilize the AI algorithm, which is trained by the training logic, to determine the AI-based confidence when the features are provided as inputs to the algorithm.

In an example embodiment, the AI model 514 includes (e.g., is) a generative language model. A generative language model is an AI model that is capable of generating original text output based on sample data. Examples of a generative language model include but are not limited to a generative pre-trained transformer 3 (a.k.a., GPT-3®) model and a generative pre-trained transformer 4 (a.k.a. GPT-4®) model, developed and distributed by OpenAI, Inc.; a large language model Meta AI (a.k.a. LLaMA®) model, developed and distributed by Meta Platforms Inc.; a language model for dialogue applications (a.k.a., LaMDA®) model and a Gemini® model, developed and distributed by Google LLC; and a BigScience large open-science open-access multilingual language model (a.k.a. BLOOM) model, developed and distributed by the BigScience collaborative initiative. A generative language model may use any suitable relevancy determination and/or ranking technique. In an example, the generative language model uses a BM25 (a.k.a. Okapi BM25) ranking function to perform its analysis (e.g., based on keywords).

In another example embodiment, the AI model 514 includes a large language model (LLM). A large language model is an artificial neural network that is capable of performing natural language processing (NLP) tasks. In an example, the large language model uses a transformer model to perform the NLP tasks. In an aspect, the large language model is trained (e.g., pre-trained) using self-supervised learning and semi-supervised learning. Examples of a large language model include but are not limited to the GPT-3® and GPT-4® models, developed and distributed by OpenAI, Inc.; the LLaMA® model, developed and distributed by Meta Platforms Inc.; and a pathways language model (a.k.a., PaLM®) model and the Gemini® model, developed and distributed by Google LLC.

In yet another example embodiment, the AI model 514 includes an embedding model. An embedding model is an AI model that uses deep learning to convert data into vectors, which represent attributes of the data, and that compares at least a subset of the vectors to determine an extent to which the vectors that are included in the subset are similar. In an example, each vector represents a semantic meaning of one or more AI prompts, one or more items referenced in the one or more AI prompts, or one or more AI responses. In an aspect, the embedding model is an encoder-only model. One example of an encoder-only model is the bidirectional encoder representations from transformers (BERT™) model, which is developed and distributed by Google LLC. In another aspect, the embedding model is a decoder-only model. In yet another aspect, the embedding model is an encoder-decoder model. One example of an encoder-decoder model is the FLAN-T5™ model, which is developed and distributed by Google LLC.

In still another example embodiment, the AI model 514 includes multiple types of AI models. In an example, weights are applied to the responses generated by the respective types of AI models. In an aspect, the AI model 514 includes a generative AI model and an embedding model. In accordance with this aspect, a first weight is applied to a first response generated by the generative AI model to provide a first weighted response, and a second weight that is different from the first weight is applied to a second response of the embedding model to provide a second weighted response. In further accordance with this aspect, the AI model 514 combines (e.g., sums) the first weighted response and the second weighted response to generate a response of the AI model 514 (e.g., the AI response 580).

In some example embodiments, the computing system 500 does not include one or more of the processor system 508, the neural processing unit 512, the prompt interaction logic 562, the data encryption logic 564, the response logic 566, the monitoring logic 568, the model execution logic 570, and/or the store 572. Furthermore, in some example embodiments, the computing system 500 includes one or more components in addition to or in lieu of the processor system 508, the neural processing unit 512, the prompt interaction logic 562, the data encryption logic 564, the response logic 566, the monitoring logic 568, the model execution logic 570, and/or the store 572.

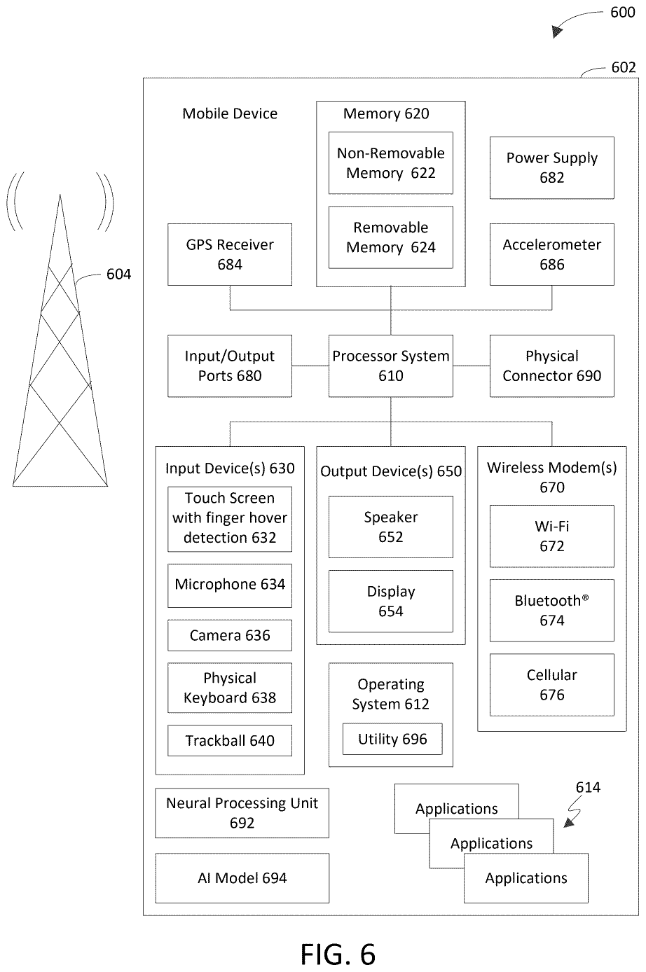

FIG. 6 is a system diagram of an example mobile device 600 including a variety of optional hardware and software components, shown generally as 602. Any components 602 in the mobile device may communicate with any other component, though not all connections are shown, for ease of illustration. In an example, the mobile device 600 is any of a variety of computing devices (e.g., cell phone, smartphone, handheld computer, Personal Digital Assistant (PDA), etc.). In another example, the mobile device 600 allows wireless two-way communications with one or more mobile communications networks 604, such as a cellular or satellite network, or with a local area or wide area network.

The mobile device 600 includes a processor system 610 (e.g., signal processor, microprocessor, ASIC, or other control and processing logic circuitry) for performing such tasks as signal coding, data processing, input/output processing, power control, and/or other functions. In an example, an operating system 612 controls the allocation and usage of the components 602 and support for one or more applications 614 (a.k.a. application programs). In another example, the applications 614 include common mobile computing applications (e.g., email applications, calendars, contact managers, web browsers, messaging applications) and any other computing applications (e.g., word processing applications, mapping applications, media player applications). The operating system 612 includes a utility 696, which is operable in a manner similar to the utility 116 described above with reference to FIG. 1 and/or the utility 516 described above with reference to FIG. 5.

The mobile device 600 includes neural processing unit 692 and AI model 694, which are operable in a manner similar to the neural processing unit 112 and the AI model 114 described above with reference to FIG. 1 and/or the neural processing unit 512 and the AI model 514 described above with reference to FIG. 5.

The mobile device 600 includes memory 620. In an example, the memory 620 includes non-removable memory 622 and/or removable memory 624. In an aspect, the non-removable memory 622 includes random access memory (RAM), read-only memory (ROM), flash memory, a hard disk, and/or other well-known memory storage technologies. In an example, the removable memory 624 includes flash memory or a Subscriber Identity Module (SIM) card, which is well known in Global System for Mobile Communications (GSM) systems, and/or other well-known memory storage technologies, such as “smart cards.” In an example, the memory 620 stores data and/or code for running the operating system 612 and the applications 614. Examples of data include but are not limited to web pages, text, images, sound files, video data, and other data sets to be sent to and/or received from one or more network servers or other devices via one or more wired or wireless networks. In an example, memory 620 stores a subscriber identifier, such as an International Mobile Subscriber Identity (IMSI), and an equipment identifier, such as an International Mobile Equipment Identifier (IMEI). In another example, such identifiers are transmitted to a network server to identify users and equipment.

In an example, the mobile device 600 supports one or more input devices 630, such as a touch screen 632, microphone 634, camera 636, physical keyboard 638 and/or trackball 640 and one or more output devices 650, such as a speaker 652 and a display 654. In an aspect, touch screens, such as the touch screen 632, detect input in different ways. In an example, capacitive touch screens detect touch input when an object (e.g., a fingertip) distorts or interrupts an electrical current running across the surface. As another example, touch screens use optical sensors to detect touch input when beams from the optical sensors are interrupted. Physical contact with the surface of the screen is not necessary for input to be detected by some touch screens. In an example, the touch screen 632 support a finger hover detection using capacitive sensing, as is well understood. Other detection techniques may be used, including camera-based detection and ultrasonic-based detection. To implement a finger hover, a user's finger is typically within a predetermined spaced distance above the touch screen, such as between 0.1 to 0.25 inches, or between 0.25 inches and 0.5 inches, or between 0.5 inches and 0.75 inches, or between 0.75 inches and 1 inch, or between 1 inch and 1.5 inches, etc.

Other possible output devices (not shown) include but are not limited to piezoelectric or other haptic output devices. In an example, some devices serve more than one input/output function. In another example, touch screen 632 and display 654 are combined in a single input/output device. In yet another example, the input devices 630 include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 612 or applications 614 include speech-recognition software as part of a voice control interface that allows a user to operate the mobile device 600 via voice commands. In another example, the mobile device 600 include input devices and software that allows for user interaction via a user's spatial gestures, such as detecting and interpreting gestures to provide input to a gaming application.

In an example embodiment, wireless modem(s) 670 are coupled to antenna(s) (not shown) and support two-way communications between the processor system 610 and external devices, as is well understood in the art. The modem(s) 670 are shown generically and may include a cellular modem 676 for communicating with the mobile communication network 604 and/or other radio-based modems (e.g., Bluetooth® 674 and/or Wi-Fi 672). At least one of the wireless modem(s) 670 is typically configured for communication with one or more cellular networks, such as a GSM network for data and voice communications within a single cellular network, between cellular networks, or between the mobile device and a public switched telephone network (PSTN).

In some example embodiments, the mobile device 600 further includes at least one input/output port 680, a power supply 682, a satellite navigation system receiver 684, such as a Global Positioning System (GPS) receiver, an accelerometer 686, and/or a physical connector 690. In an example, the physical connector 690 is a universal serial bus (USB) port, IEEE 1394 (FireWire) port, and/or RS-232 port. The illustrated components 602 are not required or all-inclusive, as any components may be deleted and other components may be added as would be recognized by one skilled in the art.

Although the operations of some of the disclosed methods are described in a particular, sequential order for convenient presentation, it should be understood that this manner of description encompasses rearrangement, unless a particular ordering is required by specific language set forth herein. In an example, operations described sequentially are in some cases rearranged or performed concurrently. Moreover, for the sake of simplicity, the attached figures may not show the various ways in which the disclosed methods may be used in conjunction with other methods.

Any one or more of the processor system 108, the operating system 110, the neural processing unit 112, the AI model 114, the utility 116, the cloud-based security service 122, the encryption service 124, the analysis service 126, the neural processing unit 212, the AI model 214, the utility 216, the cloud-based security service 222, the encryption service 224, the analysis service 226, the user interface 228, the processor system 508, the operating system 510, the neural processing unit 512, the AI model 514, the utility 516, the prompt interaction logic 562, the data encryption logic 564, the response logic 566, the monitoring logic 568, the model execution logic 570, activity diagram 200, flowchart 300, and/or flowchart 400 may be implemented in hardware, software, firmware, or any combination thereof.

In an example, any one or more of the processor system 108, the operating system 110, the neural processing unit 112, the AI model 114, the utility 116, the cloud-based security service 122, the encryption service 124, the analysis service 126, the neural processing unit 212, the AI model 214, the utility 216, the cloud-based security service 222, the encryption service 224, the analysis service 226, the user interface 228, the processor system 508, the operating system 510, the neural processing unit 512, the AI model 514, the utility 516, the prompt interaction logic 562, the data encryption logic 564, the response logic 566, the monitoring logic 568, the model execution logic 570, activity diagram 200, flowchart 300, and/or flowchart 400 is implemented, at least in part, as computer program code configured to be executed in one or more processors.

In another example, any one or more of the processor system 108, the operating system 110, the neural processing unit 112, the AI model 114, the utility 116, the cloud-based security service 122, the encryption service 124, the analysis service 126, the neural processing unit 212, the AI model 214, the utility 216, the cloud-based security service 222, the encryption service 224, the analysis service 226, the user interface 228, the processor system 508, the operating system 510, the neural processing unit 512, the AI model 514, the utility 516, the prompt interaction logic 562, the data encryption logic 564, the response logic 566, the monitoring logic 568, the model execution logic 570, activity diagram 200, flowchart 300, and/or flowchart 400 is implemented, at least in part, as hardware logic/electrical circuitry. In an aspect, such hardware logic/electrical circuitry includes one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. In an aspect, a SoC includes an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

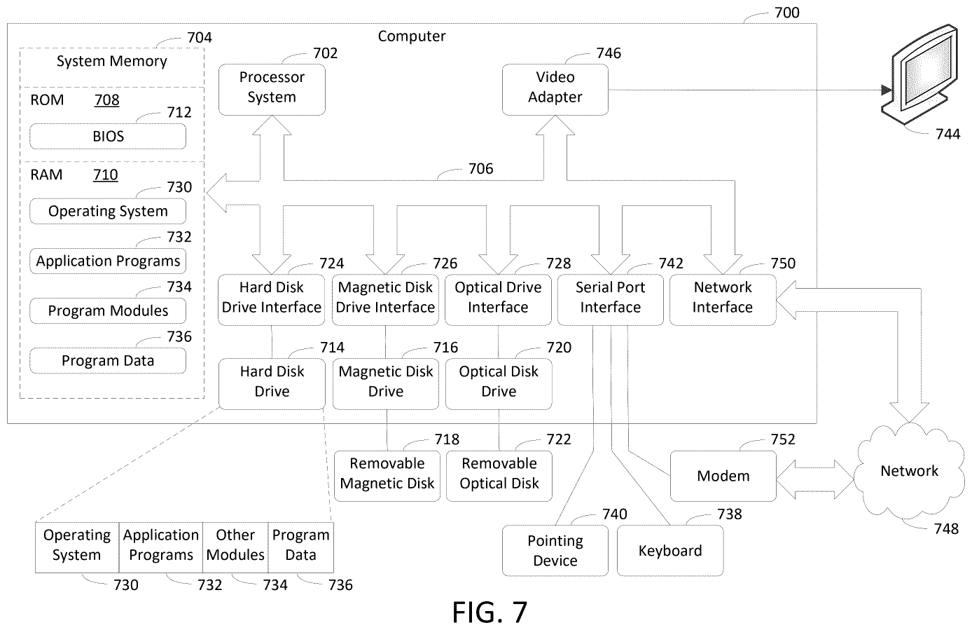

(A1) An example computing system (FIG. 1, 102A-102M; FIGS. 2, 202; FIG. 5, 500; FIGS. 6, 602; FIGS. 7, 700) comprises a processor system (FIGS. 1, 108; FIGS. 5, 508; FIGS. 6, 610; FIGS. 7, 702), a memory (FIGS. 6, 620, 622, 624; FIGS. 7, 704, 708, 710), and a neural processing unit (FIGS. 1, 112; FIGS. 2, 212; FIGS. 5, 512; FIGS. 6, 692). The processor system is configured to execute an operating system (FIGS. 5, 510; FIGS. 6, 612; FIGS. 7, 730). The operating system includes a utility (FIGS. 1, 116; FIGS. 2, 216; FIGS. 5, 516; FIGS. 6, 696) that is configured to transfer encrypted communications between the neural processing unit and a cloud-based security service (FIGS. 1, 122; FIGS. 2, 222). The memory stores the operating system and an artificial intelligence (AI) model (FIGS. 1, 114; FIGS. 2, 214; FIGS. 5, 514; FIGS. 6, 694). The neural processing unit is configured to execute (FIGS. 3, 302) the AI model. The neural processing unit is further configured to encrypt (FIGS. 2, 238; FIGS. 3, 304) AI interaction data, which includes an AI prompt (FIGS. 5, 576), using a cryptographic key (FIGS. 5, 584) to provide encrypted AI interaction data (FIGS. 5, 586). The neural processing unit is further configured to provide (FIGS. 2, 240; FIGS. 3, 306) the encrypted AI interaction data to the cloud-based security service via the utility in the operating system. The neural processing unit is further configured to receive (FIGS. 2, 256; FIGS. 3, 308) a response indicator (FIGS. 5, 574) from the cloud-based security service via the utility in the operating system. The response indicator represents a result of an analysis of a decrypted representation of the encrypted AI interaction data. The analysis includes at least one of a security analysis or a sensitivity analysis. The response indicator suggests an alternative response in lieu of an AI response (FIGS. 5, 580), which is received from the AI model as a result of the AI prompt being processed, as a response (FIGS. 5, 588) to the AI prompt. The neural processing unit is further configured to, as a result of the response indicator suggesting the alternative response in lieu of the AI response as the response to the AI prompt, provide (FIGS. 2, 260; FIGS. 3, 312) the alternative response in lieu of the AI response as the response to the AI prompt.
(A2) In the example computing system of A1, wherein the neural processing unit is configured to encrypt the AI interaction data, which includes the AI prompt and the AI response, using the cryptographic key to provide the encrypted AI interaction data.
(A3) In the example computing system of any of A1-A2, wherein the neural processing unit is configured to encrypt the AI interaction data, which includes the AI prompt and contextual information that includes context regarding the AI prompt, using the cryptographic key to provide the encrypted AI interaction data.
(A4) In the example computing system of any of A1-A3, wherein the neural processing unit is configured to: determine that the AI model accesses a file that includes sensitive information; and encrypt the AI interaction data, which includes the AI prompt and metadata indicating that the file includes the sensitive information, using the cryptographic key to provide the encrypted AI interaction data.
(A5) In the example computing system of any of A1-A4, wherein the response indicator includes the alternative response; and wherein the neural processing unit is configured to, as a result of the response indicator including the alternative response, provide the alternative response in lieu of the AI response as the response to the AI prompt.
(A6) In the example computing system of any of A1-A5, wherein the neural processing unit is configured to: as a result of the response indicator suggesting the alternative response in lieu of the AI response as the response to the AI prompt, generate the alternative response; and as a result of the alternative response being generated by the neural processing unit, provide the alternative response in lieu of the AI response as the response to the AI prompt.
(A7) In the example computing system of any of A1-A6, wherein the response indicator that is received from the cloud-based security service is encrypted; wherein the neural processing unit is configured to: decrypt the response indicator using a second cryptographic key; and as a result of the response indicator being decrypted by the neural processing unit, provide the alternative response in lieu of the AI response as the response to the AI prompt.
(A8) In the example computing system of any of A1-A7, wherein the neural processing unit is configured to: block the AI response from being provided to an entity from which the AI prompt is received by providing the alternative response in lieu of the AI response as the response to the AI prompt.
(A9) In the example computing system of any of A1-A8, wherein the neural processing unit is configured to: encrypt second AI interaction data, which includes a second AI prompt, using the cryptographic key to provide second encrypted AI interaction data; provide the second encrypted AI interaction data to the cloud-based security service via the utility in the operating system; receive a second response indicator from the cloud-based security service via the utility in the operating system, the second response indicator representing a result of a second analysis of a decrypted representation of the second encrypted AI interaction data, the second analysis including at least one of a second security analysis or a second sensitivity analysis, the second response indicator indicating a second AI response, which is received from the AI model as a result of the second AI prompt being processed, as a response to the second AI prompt; and as a result of the second response indicator indicating the second AI response as the response to the second AI prompt, provide the second AI response as the response to the second AI prompt.
(A10) In the example computing system of any of A1-A9, wherein the neural processing unit is configured to provide the second AI response as the response to the second AI prompt by performing the following: wait to enable an entity from which the second AI prompt is received to access the second AI response until the second response indicator, which indicates that the second AI response is to be provided as the response to the second AI prompt, is received.
(B1) An example method is implemented by a neural processing unit (FIGS. 1, 112; FIGS. 2, 212; FIGS. 5, 512; FIGS. 6, 692) in a computing system (FIG. 1, 102A-102M; FIGS. 2, 202; FIGS. 5, 500; FIGS. 6, 602; FIGS. 7, 700). The method comprises running (FIGS. 3, 302) an artificial intelligence (AI) model (FIGS. 1, 114; FIGS. 2, 214; FIGS. 5, 514; FIGS. 6, 694). The method further comprises encrypting (FIGS. 2, 238; FIGS. 3, 304) AI interaction data, which includes an AI prompt (FIGS. 5, 576), using a cryptographic key (FIGS. 5, 584) to provide encrypted AI interaction data (FIGS. 5, 586). The method further comprises providing (FIGS. 2, 240; FIGS. 3, 306) the encrypted AI interaction data to a cloud-based security service (FIGS. 1, 122; FIGS. 2, 222) via a utility (FIGS. 1, 116; FIGS. 2, 216; FIGS. 5, 516; FIGS. 6, 696) in an operating system (FIGS. 5, 510; FIGS. 6, 612; FIGS. 7, 730) that executes on the computing system. The method further comprises receiving (FIGS. 2, 256; FIGS. 3, 308) a response indicator (FIGS. 5, 574) from the cloud-based security service via the utility in the operating system. The response indicator represents a result of an analysis of a decrypted representation of the encrypted AI interaction data. The analysis includes at least one of a security analysis or a sensitivity analysis. The response indicator suggests an alternative response in lieu of an AI response (FIGS. 5, 580), which is received from the AI model as a result of the AI prompt being processed, as a response (FIGS. 5, 588) to the AI prompt. The method further comprises, as a result of the response indicator suggesting the alternative response in lieu of the AI response as the response to the AI prompt, providing (FIGS. 2, 260; FIGS. 3, 312) the alternative response in lieu of the AI response as the response to the AI prompt.
(B2) In the example method of B1, wherein encrypting the AI interaction data comprises: encrypting the AI interaction data, which includes the AI prompt and the AI response, using the cryptographic key to provide the encrypted AI interaction data.
(B3) In the example method of any of B1-B2, wherein encrypting the AI interaction data comprises: encrypting the AI interaction data, which includes the AI prompt and contextual information that includes context regarding the AI prompt, using the cryptographic key to provide the encrypted AI interaction data.
(B4) In the example method of any of B1-B3, further comprising: determining that the AI model accesses a file that includes sensitive information; wherein encrypting the AI interaction data comprises: encrypting the AI interaction data, which includes the AI prompt and metadata indicating that the file includes the sensitive information, using the cryptographic key to provide the encrypted AI interaction data.
(B5) In the example method of any of B1-B4, wherein receiving the response indicator comprises; receiving the response indicator, which includes the alternative response, from the cloud-based security service via the utility in the operating system; and wherein providing the alternative response in lieu of the AI response as the response to the AI prompt comprises: as a result of the response indicator including the alternative response, providing the alternative response in lieu of the AI response as the response to the AI prompt.
(B6) In the example method of any of B1-B5, further comprising: as a result of the response indicator suggesting the alternative response in lieu of the AI response as the response to the AI prompt, generating the alternative response; and wherein providing the alternative response in lieu of the AI response as the response to the AI prompt comprises: as a result of the alternative response being generated by the neural processing unit, providing the alternative response in lieu of the AI response as the response to the AI prompt.
(B7) In the example method of any of B1-B6, wherein the response indicator that is received from the cloud-based security service is encrypted; wherein the method further comprises: decrypting the response indicator using a second cryptographic key; and wherein providing the alternative response in lieu of the AI response as the response to the AI prompt comprises: as a result of the response indicator being decrypted by the neural processing unit, providing the alternative response in lieu of the AI response as the response to the AI prompt.
(B8) In the example method of any of B1-B7, wherein providing the alternative response in lieu of the AI response as the response to the AI prompt comprises: blocking the AI response from being provided to an entity from which the AI prompt is received by providing the alternative response in lieu of the AI response as the response to the AI prompt.
(B9) In the example method of any of B1-B8, further comprising: encrypting second AI interaction data, which includes a second AI prompt, using the cryptographic key to provide second encrypted AI interaction data; providing the second encrypted AI interaction data to the cloud-based security service via the utility in the operating system; receiving a second response indicator from the cloud-based security service via the utility in the operating system, the second response indicator representing a result of a second analysis of a decrypted representation of the second encrypted AI interaction data, the second analysis including at least one of a second security analysis or a second sensitivity analysis, the second response indicator indicating a second AI response, which is received from the AI model as a result of the second AI prompt being processed, as a response to the second AI prompt; and as a result of the second response indicator indicating the second AI response as the response to the second AI prompt, providing the second AI response as the response to the second AI prompt.
(B10) In the example method of any of B1-B9, wherein providing the second AI response as the response to the second AI prompt comprises: waiting to enable an entity from which the second AI prompt is received to access the second AI response until the second response indicator, which indicates that the second AI response is to be provided as the response to the second AI prompt, is received.
(C1) A second example computing system (FIG. 1, 102A-102M; FIGS. 2, 202; FIGS. 5, 500; FIGS. 6, 602; FIGS. 7, 700) comprises a memory (FIGS. 6, 620, 622, 624; FIGS. 7, 704, 708, 710) and a neural processing unit (FIGS. 1, 112; FIGS. 2, 212; FIGS. 5, 512; FIGS. 6, 692). The memory stores an operating system (FIGS. 5, 510; FIGS. 6, 612; FIGS. 7, 730) and an artificial intelligence (AI) model (FIGS. 1, 114; FIGS. 2, 214; FIGS. 5, 514; FIGS. 6, 694). The operating system includes a utility (FIGS. 1, 116; FIGS. 2, 216; FIGS. 5, 516; FIGS. 6, 696) that is configured to transfer encrypted communications between the neural processing unit and a cloud-based security service (FIGS. 1, 122; FIGS. 2, 222). The neural processing unit is coupled to the memory. The neural processing unit is configured to execute (FIGS. 3, 302) the AI model. The neural processing unit is further configured to encrypt (FIGS. 2, 238; FIGS. 3, 304) AI interaction data, which includes an AI prompt (FIGS. 5, 576), using a cryptographic key (FIGS. 5, 584) to provide encrypted AI interaction data (FIGS. 5, 586). The neural processing unit is further configured to provide (FIGS. 2, 240; FIGS. 3, 306) the encrypted AI interaction data to the cloud-based security service via the utility in the operating system. The neural processing unit is further configured to receive (FIGS. 2, 256; FIGS. 3, 308) a response indicator (FIGS. 5, 574) from the cloud-based security service via the utility in the operating system. The response indicator represents a result of an analysis of a decrypted representation of the encrypted AI interaction data. The analysis includes at least one of a security analysis or a sensitivity analysis. The response indicator suggests an alternative response in lieu of an AI response (FIGS. 5, 580), which is received from the AI model as a result of the AI prompt being processed, as a response (FIGS. 5, 588) to the AI prompt. The neural processing unit is further configured to, as a result of the response indicator suggesting the alternative response in lieu of the AI response as the response to the AI prompt, provide (FIGS. 2, 260; FIGS. 3, 312) the alternative response in lieu of the AI response as the response to the AI prompt.

### III. Example Computer System

FIG. 7 depicts an example computer 700 in which embodiments may be implemented. Any one or more of the client devices 102A-102M and/or any one or more of the servers 106A-106N shown in FIG. 1, the client device 202 shown in FIG. 2, and/or the computing system 500 shown in FIG. 5 may be implemented using computer 700, including one or more features of computer 700 and/or alternative features. In an example, computer 700 is a general-purpose computing device in the form of a conventional personal computer, a mobile computer, or a workstation. In another example, computer 700 is a special purpose computing device. The description of computer 700 provided herein is provided for purposes of illustration, and is not intended to be limiting. Embodiments are capable of being implemented in further types of computer systems, as would be known to persons skilled in the relevant art(s).

As shown in FIG. 7, computer 700 includes a processor system 702, a system memory 704, and a bus 706 that couples various system components including system memory 704 to processor system 702. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

Computer 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

In an example, a number of program modules are stored on the hard disk, magnetic disk, optical disk, ROM, or RAM. These programs include an operating system 730, one or more application programs 732, other program modules 734, and program data 736. In an aspect, application programs 732 or program modules 734 include computer program logic for implementing any one or more of (e.g., at least a portion of) the processor system 108, the operating system 110, the neural processing unit 112, the AI model 114, the utility 116, the cloud-based security service 122, the encryption service 124, the analysis service 126, the neural processing unit 212, the AI model 214, the utility 216, the cloud-based security service 222, the encryption service 224, the analysis service 226, the user interface 228, the processor system 508, the operating system 510, the neural processing unit 512, the AI model 514, the utility 516, the prompt interaction logic 562, the data encryption logic 564, the response logic 566, the monitoring logic 568, the model execution logic 570, activity diagram 200 (including any activity of activity diagram 200), flowchart 300 (including any step of flowchart 300), and/or flowchart 400 (including any step of flowchart 400), as described herein.

In an example, a user enters commands and information into the computer 700 through input devices such as keyboard 738 and pointing device 740. Other input devices (not shown) include but are not limited to a microphone, a joystick, a game pad, a satellite dish, a scanner, a touch screen, a camera, an accelerometer, and a gyroscope. These and other input devices are often connected to the processor system 702 through a serial port interface 742 that is coupled to bus 706, but may be connected by other interfaces, such as a parallel port, game port, or a universal serial bus (USB).

A display device 744 (e.g., a monitor) is also connected to bus 706 via an interface, such as a video adapter 746. In an example, computer 700 includes other peripheral output devices (not shown), such as a speaker and/or a printer, in addition to display device 744.

Computer 700 is connected to a network 748 (e.g., the Internet) through a network interface 750 (e.g., a network or adapter), a modem 752, or other means for establishing communications over the network. Modem 752 is connected to bus 706 via serial port interface 742. In an example, modem 752 is inside computer 700. In another example, modem 752 is external to computer 700.

As used herein, the terms “computer program medium” and “computer-readable storage medium” are used to generally refer to media (e.g., non-transitory media) such as the hard disk associated with hard disk drive 714, removable magnetic disk 718, removable optical disk 722, as well as other media such as flash memory cards, digital video disks, random access memories (RAMs), read only memories (ROM), and the like. A computer-readable storage medium is not a signal, such as a carrier signal or a propagating signal. In an example, a computer-readable storage medium does not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

In an example, computer programs and modules (including application programs 732 and other program modules 734) are stored on the hard disk, magnetic disk, optical disk, ROM, or RAM. In another example, such computer programs are also received via network interface 750 or serial port interface 742. Such computer programs, when executed or loaded by an application, enable computer 700 to implement features of embodiments discussed herein. Accordingly, such computer programs represent controllers of the computer 700.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment need not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A computing system comprising:
a processor system configured to execute an operating system, the operating system including a utility that is configured to transfer encrypted communications between a neural processing unit and a cloud-based security service;
a memory that stores the operating system and an artificial intelligence (AI) model; and
the neural processing unit, which is configured to perform the following:
execute the AI model;
encrypt AI interaction data, which includes an AI prompt, using a cryptographic key to provide encrypted AI interaction data;
provide the encrypted AI interaction data to the cloud-based security service via the utility in the operating system;
receive a response indicator from the cloud-based security service via the utility in the operating system, the response indicator representing a result of an analysis of a decrypted representation of the encrypted AI interaction data, the analysis including at least one of a security analysis or a sensitivity analysis, the response indicator suggesting an alternative response in lieu of an AI response, which is received from the AI model as a result of the AI prompt being processed, as a response to the AI prompt; and
as a result of the response indicator suggesting the alternative response in lieu of the AI response as the response to the AI prompt, provide the alternative response in lieu of the AI response as the response to the AI prompt.

2. The computing system of claim 1, wherein the neural processing unit is configured to encrypt the AI interaction data, which includes the AI prompt and the AI response, using the cryptographic key to provide the encrypted AI interaction data.

3. The computing system of claim 1, wherein the neural processing unit is configured to encrypt the AI interaction data, which includes the AI prompt and contextual information that includes context regarding the AI prompt, using the cryptographic key to provide the encrypted AI interaction data.

4. The computing system of claim 1, wherein the neural processing unit is configured to:
determine that the AI model accesses a file that includes sensitive information; and
encrypt the AI interaction data, which includes the AI prompt and metadata indicating that the file includes the sensitive information, using the cryptographic key to provide the encrypted AI interaction data.

5. The computing system of claim 1, wherein the response indicator includes the alternative response; and
wherein the neural processing unit is configured to, as a result of the response indicator including the alternative response, provide the alternative response in lieu of the AI response as the response to the AI prompt.

6. The computing system of claim 1, wherein the neural processing unit is configured to:
as a result of the response indicator suggesting the alternative response in lieu of the AI response as the response to the AI prompt, generate the alternative response; and
as a result of the alternative response being generated by the neural processing unit, provide the alternative response in lieu of the AI response as the response to the AI prompt.

7. The computing system of claim 1, wherein the response indicator that is received from the cloud-based security service is encrypted;
wherein the neural processing unit is configured to:
decrypt the response indicator using a second cryptographic key; and
as a result of the response indicator being decrypted by the neural processing unit, provide the alternative response in lieu of the AI response as the response to the AI prompt.

8. The computing system of claim 1, wherein the neural processing unit is configured to:
block the AI response from being provided to an entity from which the AI prompt is received by providing the alternative response in lieu of the AI response as the response to the AI prompt.

9. The computing system of claim 1, wherein the neural processing unit is configured to:
encrypt second AI interaction data, which includes a second AI prompt, using the cryptographic key to provide second encrypted AI interaction data;
provide the second encrypted AI interaction data to the cloud-based security service via the utility in the operating system;
receive a second response indicator from the cloud-based security service via the utility in the operating system, the second response indicator representing a result of a second analysis of a decrypted representation of the second encrypted AI interaction data, the second analysis including at least one of a second security analysis or a second sensitivity analysis, the second response indicator indicating a second AI response, which is received from the AI model as a result of the second AI prompt being processed, as a response to the second AI prompt; and
as a result of the second response indicator indicating the second AI response as the response to the second AI prompt, provide the second AI response as the response to the second AI prompt.

10. The computing system of claim 9, wherein the neural processing unit is configured to provide the second AI response as the response to the second AI prompt by performing the following:
wait to enable an entity from which the second AI prompt is received to access the second AI response until the second response indicator, which indicates that the second AI response is to be provided as the response to the second AI prompt, is received.

11. A method implemented by a neural processing unit in a computing system, the method comprising:
running an artificial intelligence (AI) model;
encrypting AI interaction data, which includes an AI prompt, using a cryptographic key to provide encrypted AI interaction data;
providing the encrypted AI interaction data to a cloud-based security service via a utility in an operating system that executes on the computing system;
receiving a response indicator from the cloud-based security service via the utility in the operating system, the response indicator representing a result of an analysis of a decrypted representation of the encrypted AI interaction data, the analysis including at least one of a security analysis or a sensitivity analysis, the response indicator suggesting an alternative response in lieu of an AI response, which is received from the AI model as a result of the AI prompt being processed, as a response to the AI prompt; and
as a result of the response indicator suggesting the alternative response in lieu of the AI response as the response to the AI prompt, providing the alternative response in lieu of the AI response as the response to the AI prompt.

12. The method of claim 11, wherein encrypting the AI interaction data comprises:
encrypting the AI interaction data, which includes the AI prompt and the AI response, using the cryptographic key to provide the encrypted AI interaction data.

13. The method of claim 11, wherein encrypting the AI interaction data comprises:
encrypting the AI interaction data, which includes the AI prompt and contextual information that includes context regarding the AI prompt, using the cryptographic key to provide the encrypted AI interaction data.

14. The method of claim 11, further comprising:
determining that the AI model accesses a file that includes sensitive information;
wherein encrypting the AI interaction data comprises:
encrypting the AI interaction data, which includes the AI prompt and metadata indicating that the file includes the sensitive information, using the cryptographic key to provide the encrypted AI interaction data.

15. The method of claim 11, wherein receiving the response indicator comprises;
receiving the response indicator, which includes the alternative response, from the cloud-based security service via the utility in the operating system; and
wherein providing the alternative response in lieu of the AI response as the response to the AI prompt comprises:
as a result of the response indicator including the alternative response, providing the alternative response in lieu of the AI response as the response to the AI prompt.

16. The method of claim 11, further comprising:
as a result of the response indicator suggesting the alternative response in lieu of the AI response as the response to the AI prompt, generating the alternative response; and
wherein providing the alternative response in lieu of the AI response as the response to the AI prompt comprises:
as a result of the alternative response being generated by the neural processing unit, providing the alternative response in lieu of the AI response as the response to the AI prompt.

17. The method of claim 11, wherein the response indicator that is received from the cloud-based security service is encrypted;
wherein the method further comprises:
decrypting the response indicator using a second cryptographic key; and
wherein providing the alternative response in lieu of the AI response as the response to the AI prompt comprises:
as a result of the response indicator being decrypted by the neural processing unit, providing the alternative response in lieu of the AI response as the response to the AI prompt.

18. The method of claim 11, wherein providing the alternative response in lieu of the AI response as the response to the AI prompt comprises:
blocking the AI response from being provided to an entity from which the AI prompt is received by providing the alternative response in lieu of the AI response as the response to the AI prompt.

19. The method of claim 11, further comprising:
encrypting second AI interaction data, which includes a second AI prompt, using the cryptographic key to provide second encrypted AI interaction data;
providing the second encrypted AI interaction data to the cloud-based security service via the utility in the operating system;
receiving a second response indicator from the cloud-based security service via the utility in the operating system, the second response indicator representing a result of a second analysis of a decrypted representation of the second encrypted AI interaction data, the second analysis including at least one of a second security analysis or a second sensitivity analysis, the second response indicator indicating a second AI response, which is received from the AI model as a result of the second AI prompt being processed, as a response to the second AI prompt; and
as a result of the second response indicator indicating the second AI response as the response to the second AI prompt, providing the second AI response as the response to the second AI prompt.

20. A computing system comprising:
a memory that stores an operating system and an artificial intelligence (AI) model, the operating system including a utility that is configured to transfer encrypted communications between a neural processing unit and a cloud-based security service; and
the neural processing unit coupled to the memory, the neural processing unit configured to:
execute the AI model;
encrypt AI interaction data, which includes an AI prompt, using a cryptographic key to provide encrypted AI interaction data;
provide the encrypted AI interaction data to the cloud-based security service via the utility in the operating system;
receive a response indicator from the cloud-based security service via the utility in the operating system, the response indicator representing a result of an analysis of a decrypted representation of the encrypted AI interaction data, the analysis including at least one of a security analysis or a sensitivity analysis, the response indicator suggesting an alternative response in lieu of an AI response, which is received from the AI model as a result of the AI prompt being processed, as a response to the AI prompt; and
as a result of the response indicator suggesting the alternative response in lieu of the AI response as the response to the AI prompt, provide the alternative response in lieu of the AI response as the response to the AI prompt.
